(19) United States
(12) Patent Application Publication
(10) Pub. No.: US 2004/0115426 A1
(43) Pub. Date: Jun. 17, 2004

(54) Structural material in particular suitable for vehicles such as cars

(76) Inventors: Freerk Bosma, Schipluiden (NL); Petrus Leonardus Johannus Morsink, Nootdorp (NL); Joseph Hubert Antoon Maria Huibers, Eindhoven (NL)

Correspondence Address: MUSERLIAN AND LUCAS AND MERCANTI, LLP, 475 PARK AVENUE SOUTH, NEW YORK, NY, 10016, US

(21) Appl. No.: 10/469,143

(22) PCT Filed: Feb. 26, 2002
(86) PCT No.: PCT/NL02/00123

(30) Foreign Application Priority Data
Feb. 26, 2001 (NL) 1017451

(51) Int. Cl. B32B 15/08

(52) U.S. Cl. 428/332; 428/461; 428/595

(57) ABSTRACT

The invention relates to a structural material, in particular suitable for vehicles, such as cars, comprising a laminate of at least a first and a second material layer. According to the invention it is advantageous that the laminate comprises a base layer of a relatively flexible material, such as, for instance, steel or aluminum, which base layer is coated with a supporting layer of relatively brittle material.

This patent application claims a benefit of priority from Dutch Patent Application No. 1017451 filed Feb. 26, 2001 through PCT application Ser. No. PCT/NL02/00123 filed Feb. 26, 2002, the contents of each of which are incorporated herein by reference.

The present invention relates to a vehicle body part, especially a motor vehicle hood containing a structural material comprising a laminate of at least a first and a second material layer.

Such a structural material is known in the prior art. The conference paper “Concept of hood design for possible reduction in pedestrian head injury” discloses a laminate, in particular suitable for forming a hood of a car. This conference paper was presented at “The 14th International Technical Conference on the Enhanced Safety of Vehicles”, Munich, May 23-26, 1994.

According to the above publication it is advantageous to build up the laminate from a base material of, for instance, steel, coated at the bottom with an elastic soft foam layer.

When producing vehicles, automotive manufacturers are bound to take the so-called Head Injury Criterion (HIC) into account when designing a hood for a car. The HIC gives an indication of the injury risk as a result of the deceleration the head of a human undergoes at the moment this human is knocked down by a car and hits his head on the surface of a hood. The HIC is defined as follows:

$$HIC = {[ \frac{1}{{t}_{2} - {t}_{1}} {\int }_{{t}_{1}}^{{t}_{2}} a ⅆ t ]}^{2 , 5} ( {t}_{2} - {t}_{1} )$$

In this equation the interval t₁-t₂ forms the interval over which the deceleration of the head of a human is measured. This interval is selected such that the maximum deceleration and hence the maximum load on the head of a human is determined.

In the prior art it is known that the head of a human can undergo a very great deceleration during a short interval without permanent damage necessarily occurring in the head. After this short period with a high deceleration, however, the deceleration must revert to a much less high value. If this does not happen, the risk of injury increases.

In the prior art it is required that in every place on the hood the HIC value is lower than 1000. The equation shows that it is advantageous if the deceleration is spread over a longest possible time interval. In practice, this means that during this long time interval a hood can deform under the load on the head.

When the time interval over which the hood can deform is great, the associated deformation of a hood will also be great. Structurally, this requires a large open space between the hood and the subjacent parts of the car. It is clear that a maximum must be set on this open space. The larger this open space must be, the more unfavorable it will be to the total design of the car, for instance from the viewpoint of aerodynamics and freedom of design when designing the different engine parts.

Structurally, the ideal would be to make the hood from a material having a relatively high stiffness during the first deformation of the hood. When a head of a human hits such a hood, a great deceleration can be forced on the head for a specific time interval. Ideally, the material properties of the hood should then change to give the hood a much greater flexibility over a next time interval and to cause the deceleration of the head of a human to revert to a much less high value.

By means of the structure known from the above-discussed conference paper an attempt is made to catch the head of a human as much as possible and to direct it in the best possible manner towards the engine located under the hood. The material properties of the hood according to the above document, however, are constant during the deformation of the hood. This means that with the laminate according to the conference paper a compromise must still be sought between, on the one hand, a largest possible range over which the head can be slowed down and, on the other hand, a smallest possible range so as not to restrict the freedom of design too much when designing the car.

A layered structural material for car plating is further known from JP-A-06023775. This material is composed of a molded piece of SMC (Sheet Mold Compound) coated with a metallic foil. SMC is composed of long fibers included in a matrix material. SMC is thus a relatively tough material that, coated with metallic foil, is suitable for replacing metallic car plating parts, because this material has a relatively great stiffness.

From JP-A-01135860 it is known that a steel plate storable for a rather long time is coated, for the purpose of increasing its stiffness, with an epoxy resin containing, inter alia, SBR, NBR, IIR, a curing agent, a filling material and glass particles.

In view of above, the object of the present invention is to provide a vehicle body part with a structural material, in which the disadvantages of the materials according to the prior art are avoided as much as possible, that is to say in which an optimum can be obtained between the degree of deceleration and the degree of dent.

According to the invention this object is achieved if the laminate comprises a base layer of a relatively flexible material, such as, for instance, steel or aluminum, which layer is coated with a supporting layer of relatively brittle material.

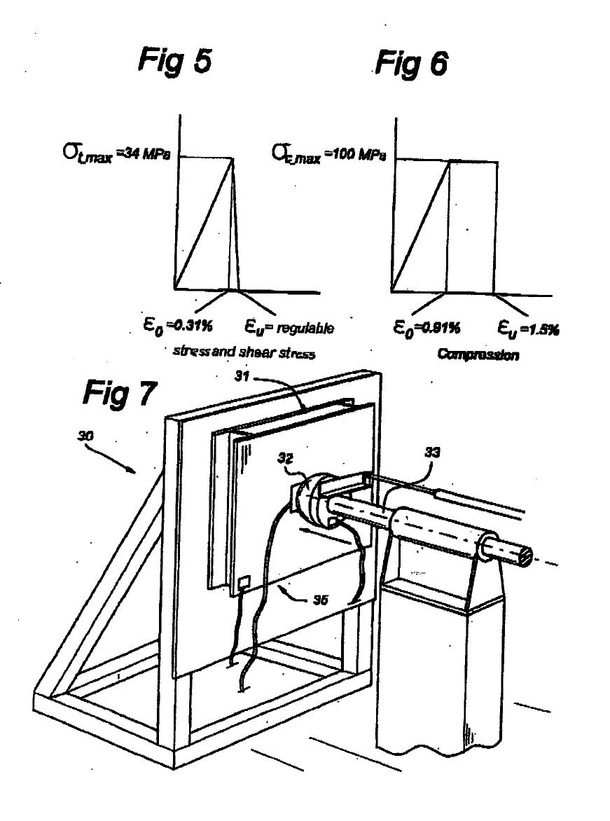

For clarity's sake, it is observed that in the present text the term “brittle material” refers to a material that either breaks when exceeding a specific stretch or whose stiffness strongly decreases when exceeding a specific maximum stretch, e.g. a material with properties as shown in FIGS. 5 and 6. This maximum stretch is, for instance, the elastic limit of the material.

Through the above-mentioned measure it is ensured that the vehicle body part according to the invention has a first stiffness of relatively high value over a first deformation range. Because the material has this stiffness, it will be capable of forcing a relatively great deceleration on an object hitting it, such as, for instance the head of a human, over the first range.

At the moment a maximum stretch is exceeded, either the brittle supporting material will break or its stiffness will sharply decrease. This means that after exceeding this maximum stretch of the supporting material the material will show a second deformation range, in which the stiffness of the material will be lower than over the first deformation range.

Through the combination of the relatively flexible, i.e. ductile, base material and the relatively brittle supporting material it is substantially ensured during deformation of the structural material that the material properties of the structural material depend on the degree of deformation thereof.

By using the structural material in a vehicle body part according to the invention, it can be ensured that a relatively great deceleration is forced on the head of a human over a first range. When exceeding a specific deformation of a hood, the brittle material will either break or lose its stiffness. Subsequently, a much lower deceleration can be forced on the head in a second deformation range. The base layer deforms plastically, which prevents load on the head as a result of the rebound of the laminate. This means that by the vehicle body part according to the present invention the object according to the invention is substantially achieved.

According to the invention it is advantageous that the stiffness of the supporting layer strongly decreases when increasing the stretch above the elastic limit of the material of the supporting layer. It is possible that this supporting material comprises BMC (Bulk Mold Compound).

Besides the above base material and the above supporting material, the structural material in the vehicle body part according to the invention may also comprise a filling layer arranged between the base layer and the supporting layer. This filling layer may, for instance, comprise PVC foam. The object of this layer is to create distance between the base layer and the supporting layer. This may also be achieved by applying a relief to the supporting material.

As stated, the structural material is used in a vehicle body part according to the invention. Hereby it is of advantage that the base layer comprises steel having a thickness of 0.6 to 2.0 mm, preferably 0.6 to 0.9 mm, most preferably 0.7 mm, or that the base layer comprises aluminum having a thickness of 1.0 to 2.0 mm, preferably 1.0 to 1.5 mm, most preferably 1.2 mm.

It is further possible that the supporting layer has a thickness of 0 to 10 mm, preferably 1 to 3 mm, most preferably 2 mm.

The supporting layer may, for instance, be made of a composite material that can be formed in a mold, which supporting layer is fixed to the base layer by means of, for instance, an epoxy glue. It is thus possible that the layer thickness of the supporting layer varies over the surface of the hood.

By varying the thickness of the supporting layer over the surface of the hood specific material characteristics can be given to specific places on the hood. That is to say in places where, for instance, the material of the base layer is bent (and is therefore less flexible) the subjacent supporting layer may be of thinner design or even be completely omitted.

As stated, it is necessary according to the prior art that in every place on the hood the HIC value is lower than 1000. That is to say that this requirement is also imposed on the transition existing between the hood and the juxtaposed wings. By integrating the wings, at least at the top thereof, with the hood it can be ensured in a single design that the HIC value is actually lower than the above value of 1000.

The invention will be described in more detail with reference to the accompanying figures, in which:

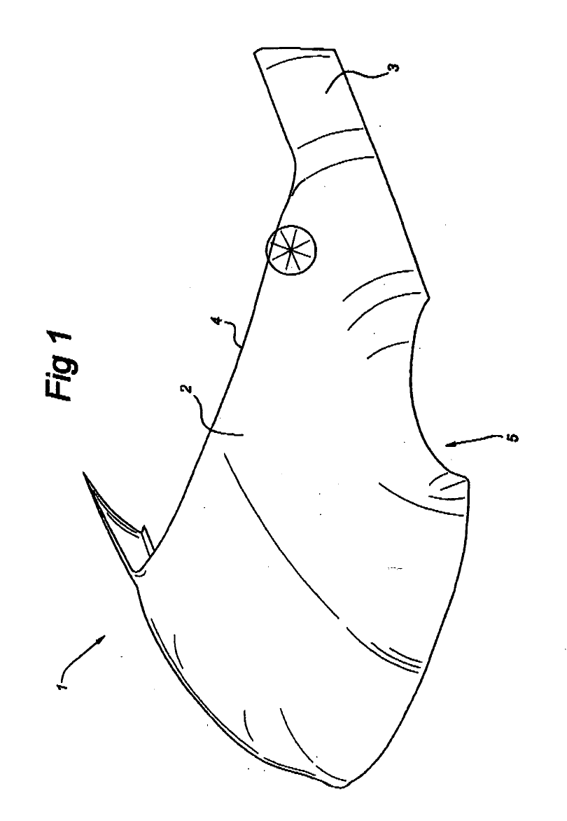

FIG. 1 shows a possible design of a hood according to the present invention;

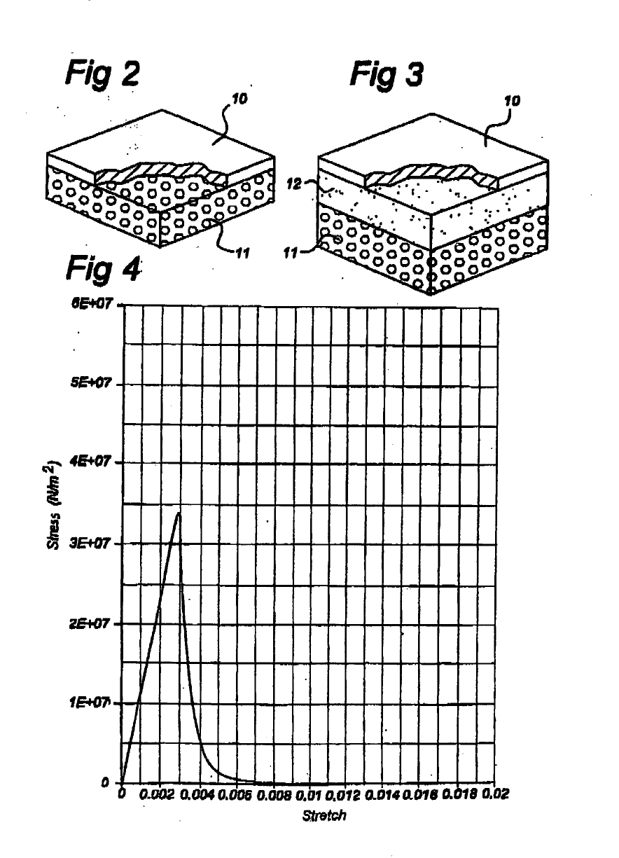

FIG. 2 shows the building up of the structural material used in a vehicle body part according to the invention with a base layer and a supporting layer;

FIG. 3 shows the structural material used in a vehicle body part according to the invention, in which a filling layer is arranged between the supporting layer and the base layer;

FIGS. 4, 5 and 6 show the ratio between the stress and the associated stretch of a material that can be preferably used as supporting layer for the structural material used in a vehicle body part according to the invention;

FIG. 7 shows a possible arrangement for testing the structural material used in a vehicle body part according to the invention;

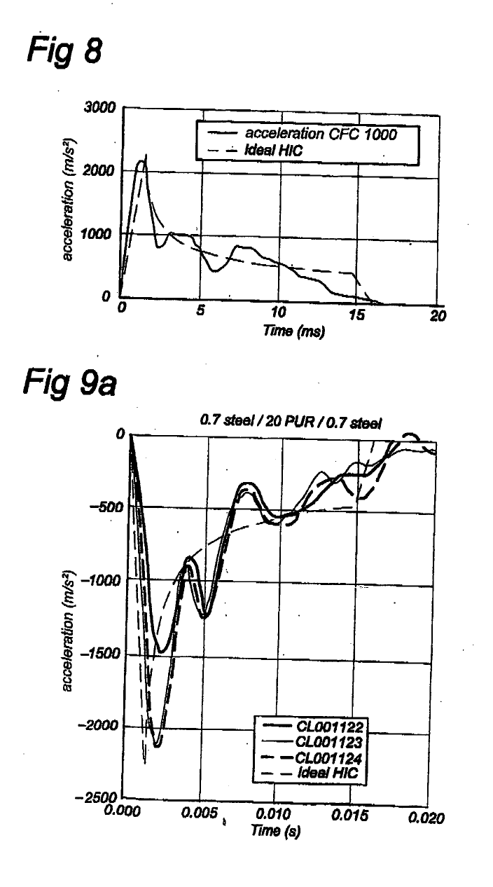

FIG. 8 shows a diagram of the properties of the structural material used in a vehicle body part according to the invention tested in the arrangement of FIG. 7; and

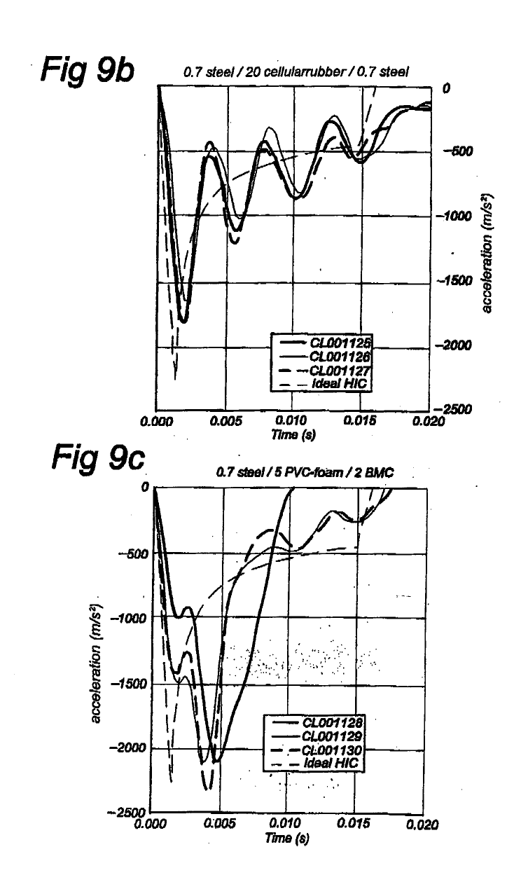

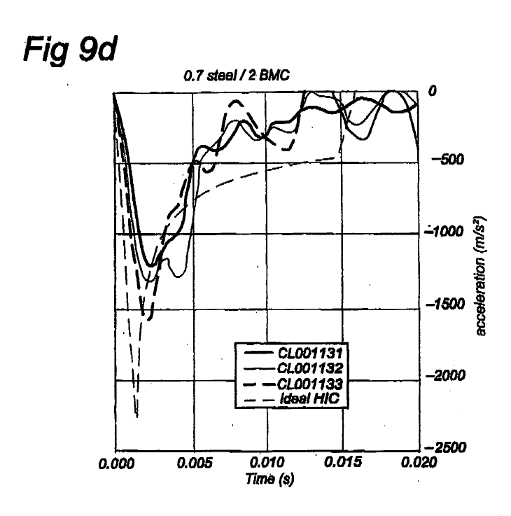

FIGS. 9a, 9b, 9c and 9d show, in the form of diagrams, the results of tests carried out by means of the arrangement of FIG. 7.

FIG. 1 shows a hood 1, which is built up with a structural material. As will be discussed with reference to FIGS. 2 and 3, the structural material of a hood 1 comprises a base layer of, for instance, steel and a supporting layer of, for instance, a composite material. The hood 1 of FIG. 1 comprises a first central part 2, which, in use, will cover the engine at the top. On both sides, the central part 2, extended by side parts 3, which, in use, will substantially extend in the vertical direction and form the wings of a car. At the edge 4 the central part 2 will connect to the windscreen of a car. In the central part holes are further provided to accommodate, for instance, a light unit.

FIG. 2 diagrammatically shows the building up of the structural material used in a vehicle body part according to the invention. The structural material comprises a base layer 10, for instance formed from steel. The steel base layer can be easily deformed and can, moreover, be finished in the conventional manner with protective layers and paint layers etc. Arranged at the bottom of this base layer is a supporting layer 11. The particular aspect of this supporting layer is that it is made of brittle material. When a force is exerted on the material 10, 11, the material will deform. Over a first deformation range the resistance to bending will be determined by the material properties of both the base layer 10 and the supporting layer 11. When a specific degree of deformation is exceeded, the brittle material will either break or lose its stiffness. That is to say that from that moment the material properties of substantially the base material 10 will determine the further resistance to bending over the deformation range.

FIG. 3 shows an alternative embodiment of the structural material used in a vehicle body part according to the invention. Besides the base material 10 and the brittle material 11, the material according to the embodiment of FIG. 3 also comprises a filling material 12. This filling material 12 is, for instance, formed by PVC foam or by means of a relief on the supporting material.

FIGS. 4, 5 and 6 show the ratio between the stress and the associated stretch of a material that is eminently suitable to serve as supporting material 11. The material has the code name of BMC (Bulk Mold Compound). The material contains 5 wt. % glass fibers having a length of 6 mm. The material further contains a considerable amount of mineral (lime). The density of the material is 1800. The material has a yield stress of 34 MPa. FIG. 4 shows that when the stress exerted on the material exceeds the yield stress, the stiffness of the material sharply decreases.

FIG. 5 shows a picture similar to that of FIG. 4. The yield point of the material is at 34 MPa. The associated deformation is, for instance, 0.31%. The specific strength depends on the selected material thickness.

FIG. 6 shows the behavior of the material under compression stress.

Applicant conducted experiments with the structural material used in a vehicle body part according to the invention. The arrangement used by applicant is drawn in FIG. 7. FIG. 7 shows a so-called impact tester 30. The impact tester 30 comprises frame 31, in which a test piece can be clamped. The tester further comprises a so-called “head form”. This head form is a freely moving mass having a weight of 4.8 kg, imitating the head of an adult human. The arrangement used by applicant corresponds to the requirements of the European Enhanced Vehicle Safety Committee Working Group 17. The head form 32 is moved in the direction of the test piece 35 by means of a cylinder 33. The speed at which this occurs is 11.1 m/s. A survey of the tests conducted by applicant is contained in Table 1 below.

TABLE 1

| | Material | | Maximum | Maximum | |
|---|---|---|---|---|---|
| | layer | Impactor | head form | head form | |
| Test | thickness | speed | acceleration | displacement | |
| number | (mm) | (m/s) | (m/s²) | (mm) | HIC |
| CL001122 | 0.7 Steel/ | 8.54 | 1700 | 33 | 775 |
| | 20 PUR/ | | | | |
| | 0.7 Steel | | | | |
| CL001123 | Idem | 11.45 | 2440 | 50 | 1184 |
| CL001124 | Idem | 11.36 | 2340 | 46 | 1274 |
| CL001125 | 0.7 Steel/ | 11.32 | 2220 | 60 | 828 |
| | 20 cell | | | | |
| | rubber/ | | | | |
| | 0.7 Steel | | | | |
| CL001126 | Idem | 11.45 | 2110 | 70 | 646 |
| CL001127 | Idem | 11.29 | 2230 | 63 | 870 |
| CL001128 | 0.7 Steel/ | 8.67 | 2340 | 27 | 1824 |
| | 5 PVC foam/ | | | | |
| | 2 MBC | | | | |
| CL001129 | Idem | 11.44 | 2390 | 43 | 1553 |
| CL001130 | Idem | 11.32 | 2890 | 44 | 1700 |
| CL001131 | 0.7 Steel/ | 8.59 | 1490 | 54 | 443 |
| | 2 BMC | | | | |
| CL001132 | Idem | 9.86 | 1660 | 66 | 670 |
| CL001133 | Idem | 11.23 | 1950 | 104 | 566 |

FIG. 8 diagrammatically shows the results of the tests conducted by means of the arrangement of FIG. 7. The full line indicates the profile of the deceleration of a head for the time most advantageous to a human. The dash line indicates the profile that can be obtained with the material used in a vehicle body part according to the invention.

FIGS. 9a, 9b, 9c and 9d further show, in the form of diagrams, the results of experiments conducted by means of the arrangement of FIG. 7. The above table shows the properties of the different material compositions tested in the experiment.

1. A motor vehicle hood, containing a structural material, comprising a laminate of at least a first and a second material layer, characterized in that the laminate comprises a base layer of a relatively flexible material, such as, for instance, steel or aluminum, which base layer is coated with a supporting layer of relatively brittle material.

2. A hood according to claim 1, characterized in that the stiffness of the supporting layer strongly decreases when increasing the stretch above the elastic limit of the material of the supporting layer.

3. A hood according to claim 1 or 2, characterized in that the supporting material comprises BMC.

4. A hood according to claims 1-3, characterized in that between the base layer and the supporting layer a filling layer is arranged to increase the distance between the base layer and the supporting layer.

5. A hood according to any of the preceding claims, characterized in that the base layer comprises steel having a thickness of 0.6 mm to 2.0 mm, preferably 0.6 mm to 0.9 mm, most preferably 0.7 mm.

6. A hood according to any of the preceding claims, characterized in that the base layer comprises aluminum having a thickness of 1.0 mm to 2.0 mm, preferably 1.0 mm to 1.5 mm, most preferably 1.2 mm.

7. A vehicle body part according to any one of the preceding claims, characterized in that the supporting layer has a thickness of 0 to 10 mm, preferably 1 to 3 mm, most preferably 2 mm.

8. A hood according to any one of the preceding claims, characterized in that the layer thickness of the supporting layer varies over the surface of the hood.
